(19) United States
(12) Patent Application Publication
(10) Pub. No.: US 2004/0195314 A1
(43) Pub. Date: Oct. 7, 2004

(54) Credit transaction system and method using fingerprint information

(76) Inventor: Ki Deak Lee, Seoul (KR)

Correspondence Address: Jonathan P. Osha, OSHA NOVAK & MAY L.L.P., Suite 2800, 1221 McKinney Street, Houston, TX, 77010, US

(21) Appl. No.: 10/818,595

(22) Filed: Apr. 6, 2004

(30) Foreign Application Priority Data
Apr. 7, 2003 (KR) 10-2003-0021723

(51) Int. Cl. G06F 17/60; G06K 5/00

(52) U.S. Cl. 235/380

(57) ABSTRACT

A credit transaction system and a method thereof using fingerprint information strengthen an authentication function of a card user's identity. The system includes a terminal for credit transactions which has a function of authenticating the identity of the card user using the fingerprint and transmits transaction particulars and card information of the card user; a transaction approval determining unit for receiving the transaction particulars and the card information from the terminal, confirming a credit status of the card user, and informing an approval/rejection of the transactions to the terminal; and a management server, connected to the terminal, for mutually communicating the fingerprint information and the card information with the terminal.

This application claims the benefit of the Korean Application No. P 2003-21723 filed on Apr. 7, 2003, which is hereby incorporated by reference.

### BACKGROUND OF THE INVENTION

1. Field of the Invention

The present invention relates to a credit transaction system, and more particularly, to a credit transaction system and method using fingerprint information.

2. Discussion of the Related Art

Recently, credit transactions using credit cards, point cards, debit cards, etc., are on the increase. Generally, the credit transactions are carried on in a manner that when a customer registered in a credit card company intends to purchase goods or obtain services, the credit card company first confirms if the corresponding customer is a registered customer of the company, and if so, the credit card company approves the transactions.

A related art credit transaction system includes a point of sales system (POS) provided in a member store, a server of a value added network (VAN) service provider that provides a credit card VAN service, and a server of a credit card company that approves the transactions after confirming the credit information of the customer.

If a customer intends to purchase goods, the related art credit transaction system as constructed above reads out information of the credit card for settlement of the purchased good through a POS, and then requests an approval of the credit card to the server of the VAN service provider. Then, the credit card company approves the transactions after confirming the credit information such as a membership and a credit limit of the credit card user who requested the settlement.

However, since the related art credit transaction system approves the credit card transactions only after confirming the credit information of the credit card without any procedure of authenticating whether the card holder is the person himself/herself who is registered in the corresponding credit card company, an illegal use of a card may be approved. That is, the approval of the transactions may be obtained even through the use of a robbed or forged card, and this may cause the original customer to be greatly damaged.

### SUMMARY OF THE INVENTION

Accordingly, the present invention is directed to a credit transaction system and method using fingerprint information that substantially obviates one or more problems due to limitations and disadvantages of the related art.

An object of the present invention is to provide a credit transaction system and method using fingerprint information that can strengthen an authentication function of a card user's identity.

Another object of the present invention is to provide a credit transaction system and method using fingerprint information that can perform an authentication of a card user's identity even when a network is disconnected, and reduce the time required for credit card transactions.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a credit transaction system using fingerprint information includes a terminal for credit transactions which has a function of authenticating an identity of a card user using a fingerprint and transmits transaction particulars and card information of the card user, a transaction approval determining unit for receiving the transaction particulars and the card information from the terminal, confirming a credit status of the card user, and informing an approval/rejection of the transactions to the terminal, and a management server, connected to the terminal, for mutually communicating the fingerprint information and the card information with the terminal.

Here, the terminal for the credit transactions includes a fingerprint recognition unit for scanning the fingerprint of the card user, a database unit for storing the fingerprint information and the card information of pre-registered card users, and a control unit for confirming the identity of the card user by comparing the fingerprint of the card user scanned by the fingerprint recognition unit with the fingerprint information stored in the database unit.

The credit transaction system further includes a fingerprint registration unit for scanning the fingerprint of the card user in order to register the fingerprint of the card user, and transmitting the fingerprint of the card user and the corresponding card information to the management server.

In another aspect of the present invention, a credit transaction method for a credit transaction system having a terminal for credit transactions, a transaction approval determining unit, and a management server, includes (a) scanning a fingerprint of a card user using the terminal, (b) confirming an identity of the card user by comparing the scanned fingerprint of the card user with fingerprint information stored in the terminal, (c) requesting a transaction approval to the transaction approval determining unit, and (d) the transaction approval determining unit determining an approval/rejection of the transactions after confirming a credit status of the card user.

The credit transaction method further includes displaying a message for requesting an input of transaction particulars of the card user on the terminal after confirming the identity of the card user, and inputting the transaction particulars of the card user through the terminal.

The credit transaction method further includes the terminal transmitting changed card information of the card user to the management server after the approval/rejection of the transactions is determined, and updating respective terminals for the credit transactions using data of the management server.

At the step of confirming the identity of the card user, if the card of the card user is read out by the terminal, the terminal calls a fingerprint corresponding to the card number of the card user among fingerprint data stored therein and compares the fingerprint with the scanned fingerprint.

Meanwhile, at the step of confirming the identity of the card user, if the card of the card user is not read out by the terminal, the terminal judges whether there is a fingerprint which coincides with the scanned fingerprint among the fingerprint data stored therein.

In still another aspect of the present invention, a credit transaction system using fingerprint information includes a user authentication unit for authenticating an identity of a card user by comparing a fingerprint of the card user with pre-stored fingerprint information, a terminal for credit transactions for transmitting transaction particulars and card information of the card user in accordance with a result of the authentication performed by the user authentication unit, a transaction approval determining unit for receiving the transaction particulars and the card information of the card user from the terminal, confirming a credit status of the card user, and informing an approval/rejection of the transactions to the terminal, and a management server, connected to the user authentication unit, for mutually communicating the fingerprint information and the card information with the user authentication unit.

Here, the user authentication unit includes a fingerprint recognition unit for scanning the fingerprint of the card user, a database unit for storing the fingerprint information and the card information of pre-registered card users, and a control unit for authenticating the identity of the card user by comparing the fingerprint of the card user scanned by the fingerprint recognition unit with the fingerprint information stored in the database unit.

The credit transaction system further includes a keyboard for inputting key values, and a keyboard sharer for selectively transferring the key values of the keyboard to the terminal or the user authentication unit.

The keyboard sharer includes a switch for switching connection of the keyboard to the terminal or the user authentication unit, and a CPU for controlling the switch.

In still another aspect of the present invention, a credit transaction method for a credit transaction system having a user authentication unit, a terminal for credit transactions, a transaction approval determining unit, and a management server, includes (a) scanning a fingerprint of a card user using the user authentication unit, (b) confirming an identity of the card user by comparing the scanned fingerprint of the card user with fingerprint information stored in the user authentication unit, (c) transmitting card information and transaction particulars of the card user to the transaction approval determining unit, (d) the transaction approval determining unit determining an approval/rejection of the transactions after confirming a credit status of the card user, and (e) informing the approval/rejection of the transactions to the terminal.

The credit transaction method further includes displaying a message for requesting an input of the transaction particulars of the card user on the terminal after authenticating the identity of the card user, and inputting the transaction particulars of the card user to the terminal.

The credit transaction method further includes the user authentication unit transmitting changed card information of the card user to the management server after the approval/rejection of the transactions is reported to the terminal, and updating data stored in respective user authentication units using data of the management server.

The management server periodically transmits newly registered fingerprint information and changed card information to the user authentication unit, or transmits the newly registered fingerprint information and the changed card information to the user authentication unit whenever the user authentication unit is logged in the management server.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a block diagram of a credit transaction system according to the first embodiment of the present invention;

FIG. 2 illustrates a block diagram of a terminal and a user authentication unit of FIG. 1 connected together;

FIG. 3 illustrates a block diagram of the user authentication unit;

FIG. 4 illustrates a flowchart of a credit transaction process using the credit transaction system according to the first embodiment of the present invention;

FIG. 5 illustrates a block diagram of a credit transaction system according to the second embodiment of the present invention;

FIG. 6 illustrates a block diagram of a terminal for credit transactions of FIG. 5; and

FIG. 7 illustrates a flowchart of a credit transaction process using the credit transaction system according to the second embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

### First Embodiment

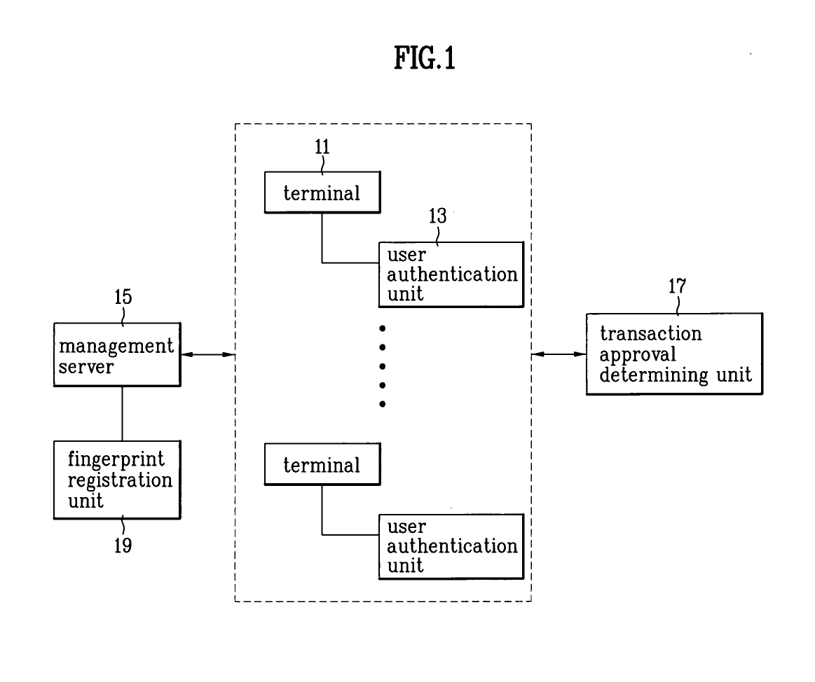

FIG. 1 illustrates a block diagram of a credit transaction system according to the first embodiment of the present invention. As shown in FIG. 1, a user authentication unit 13, which authenticates users of credit cards, point cards, debit cards, etc., is provided in a respective member store or shop. The user authentication unit 13 recognizes a fingerprint of a card user, and then authenticates whether the card user is a customer registered in the corresponding credit card company or banking company by comparing the fingerprint of the card user with pre-registered fingerprint information.

The credit transaction system according to the first embodiment of the present invention includes a terminal 11 for serving as a point of sales system (POS), a management server 15 for correcting, deleting or updating information stored in the user authentication units of the respective member stores or shops, and a transaction approval determining unit 17 for receiving transaction particulars and card information of the card user from the terminal 11, confirming a credit status of the card user, and determining an approval/rejection of the transactions. Here, the management server 15 is connected to the respective user authentication units 13 through telephone networks, private lines or Internet, and may be a central server of a large-sized store or a server of a credit card company. Also, the transaction approval determining unit 17 of the credit card company is connected to the terminals 11 of the respective member stores through telephone networks, private lines or the Internet.

The credit transaction system according to the first embodiment of the present invention may further include a fingerprint registration unit 19 for registering the fingerprints of the card users. It is possible to register the fingerprints using the user authentication units of the respective member stores, but it is preferable to register the fingerprints through the fingerprint registration units 19 in specified places designated by the credit card company for a thorough identity confirming procedure. The fingerprint registration unit 19 includes a fingerprint recognition unit for scanning the fingerprint of the card user, and a database unit for storing the fingerprints of the registered card users in a fixed format.

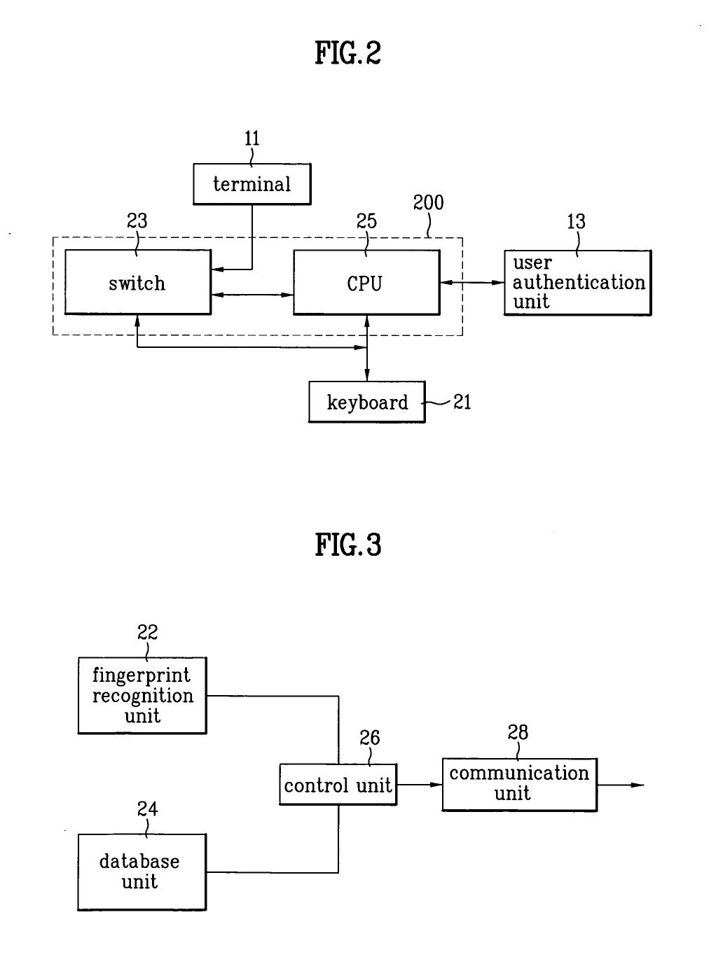

As shown in FIG. 2, the credit transaction system according to the first embodiment of the present invention further includes a keyboard 21, and a keyboard sharer 200 connected between the terminal 11 and the user authentication unit 13. The keyboard sharer 200 includes a switch for switching connection of the keyboard 21 to the terminal 11 or the user authentication unit 13, and a CPU 25 for controlling the switch 23. The switch 23 selectively transfers the key values of the keyboard 21 to the terminal 11 or the user authentication unit 13. This is because the keyboard 21 cannot be simultaneously shared by the terminal 11 and the user authentication unit 13.

As shown in FIG. 3, the user authentication unit 13 includes a fingerprint recognition unit 22 for scanning the fingerprint of the card user and converting the scanned fingerprint into fingerprint data, a database unit 24 for storing the fingerprint into fingerprint information, a database unit 24 for storing the fingerprints of the card users registered in the credit card company in a fixed format, a control unit 26 for judging whether the card user is a customer registered in the corresponding credit card company by comparing the fingerprint of the card user recognized by the fingerprint recognition unit 22 with the fingerprint stored in the database unit 24, and a communication unit 28 for connecting to the management server 15 in order to exchange the fingerprint information and the card information with the management server 15.

Here, in the embodiment of the present invention, the fingerprint recognition unit 22 is used for scanning the fingerprint of the card user, but it may be replaced with a biomedical sensor for recognizing biomedical information of the card user. For example, an eyeball sensor for sensing an eyeball of the card user may be used. Meanwhile, the database unit 24 may store therein diverse information of the card users such as the card numbers of users, credit limits, commission rates, points reserved according to the use of the card, etc., in addition to the fingerprints of the registered users. The control unit 26 may comprise a microprocessor having an arithmetic function.

Also, it will be apparent that the credit transaction system according to the present invention further includes constituent elements required for the existing credit transaction system.

Now, the credit transaction method performed in the credit transaction system according to the first embodiment of the present invention will be explained.

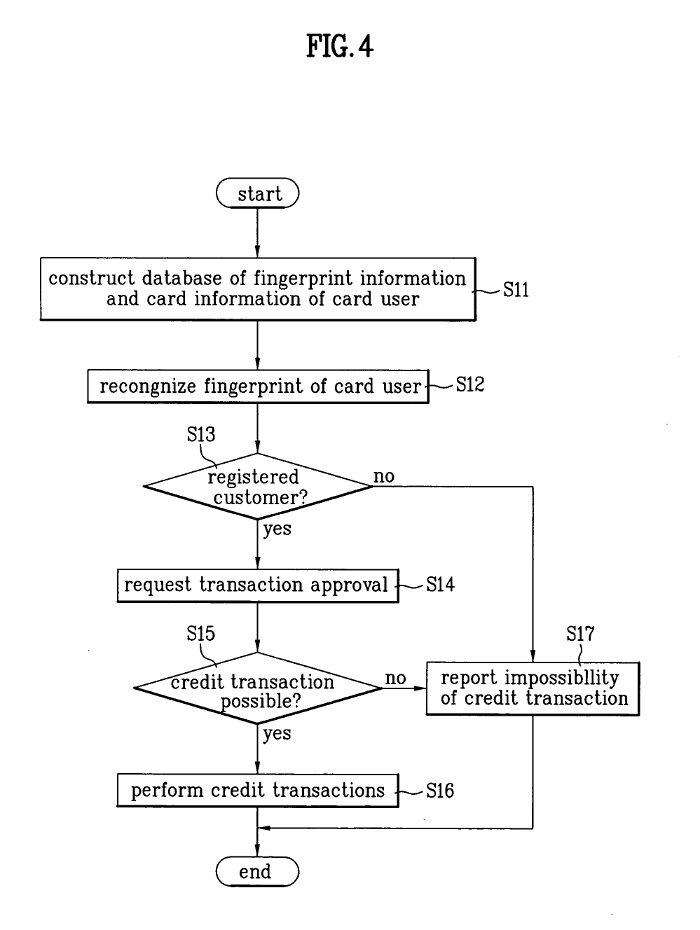

FIG. 4 illustrates a flowchart of a credit transaction process using the credit transaction system according to the first embodiment of the present invention. Referring to FIG. 4, in order to operate a credit transaction system, fingerprints of the card users are first registered and stored as a database. It is possible to register the fingerprints in the respective member stores, but it is preferable to register the fingerprints in specified places designated by the credit card company for a thorough identity confirming procedure. Thus, after the fingerprints of the card users are scanned for the fingerprint registration, the fingerprints corresponding to the card numbers of the respective users are registered. At this time, a plurality of fingerprints can be registered with respect to one card number. For example, if members of a family intend to commonly use one card, the fingerprints of the members of the family can be registered with respect to one card number. Such fingerprint data are stored in the database unit of the fingerprint registration unit 19 along with the card information.

The fingerprints as registered above are transmitted to and stored in the management server 15 in the form of data. The management server 15 transfers the registered fingerprints and the card information to the user authentication unit 13 in the respective member stores through a communication network. The user authentication unit 13, which received the fingerprints and the card information, stores them in the internal database unit 24 to construct a database (step S11).

Also, the management server 15 transmits the fingerprints of the card users registered at any time and the corresponding card information to the user authentication unit 13 to update the database unit 24 of the user authentication unit 13. The management server 15 updates the database unit 24 whenever the user authentication unit 13 is logged in, or periodically updates the database unit. Here, the management server 15 and the database unit 24 can store therein diverse information of the card users such as the card numbers of users, credit limits, commission rates, points reserved according to the use of the card, etc., in addition to the fingerprints of the registered users.

Thereafter, if the card user intends to purchase goods or obtain services, the card of the user is read out through the terminal 11, and the fingerprint of the card user is scanned through the fingerprint recognition unit 22 of the user authentication unit 13 (step S12). At this time, the process of reading the card of the user through the terminal 11 may be omitted.

Then, if the card is read through the terminal 11, the control unit 26 of the user authentication unit 13 calls the fingerprint corresponding to the card number among the fingerprint data stored in the database unit 24, and judges whether the card user is a customer registered in the corresponding credit card company by comparing the fingerprint of the card user scanned by the fingerprint recognition unit 22 with the fingerprint stored in the database unit 24 (step S13).

Meanwhile, if the card is not read through the terminal 11, the control unit 26 of the user authentication unit 13 confirms if there is a fingerprint that coincides with the fingerprint scanned by the fingerprint recognition unit 22 among the fingerprint data stored in the database unit 24. If the fingerprint that coincides with the scanned fingerprint is stored in the database unit 24, the card user is judged to be a registered customer, and if not, the card user is judged not to be a registered customer.

If the card user is authenticated through the above-described authentication procedure, the user authentication unit 13 transfers the result of authentication to the terminal 11. If it is judged that the card user is a registered customer, the terminal 11 displays a message for requesting an input of transaction particulars of the card user. Thereafter, the transaction particulars of the card user, i.e., the price of the good that the card user purchased, are inputted to the terminal 11 through the keyboard 21. At this time, the keyboard 21 is connected to the terminal 11, but is not connected to the user authentication unit 13 by the switch 23.

Then, the terminal 11 transfers the transaction particulars of the corresponding card user and the card information to the transaction approval determining unit 17 of the credit card company through the communication network to request the transaction approval (step S14). Only in the case that the card user is authenticated to be a registered customer, the terminal transfers the transaction particulars and card information of the card user to the transaction approval determining unit 17. Here, the card information that the terminal 11 transfers to the transaction approval determining unit 17 may be read out from the database unit 24 of the user authentication unit 13 or from the management server 15. In other words, in order to transmit the latest updated card information to the transaction approval determining unit 17, it is preferable to read out the card information stored in the management server 15, but in the case that the network between the terminal 11 and the management server 15 is disconnected, the terminal 11 transmits the card information stored in the database unit 24 of the user authentication unit 13.

Thereafter, the transaction approval determining unit 17 judges whether to approve the transaction by inquiring about the credit status of the card user (step S15). For example, if the volume of transactions of the card user is within the credit limit and the user is not an ill-credited man/woman, the transaction approval determining unit 17 approves the transactions of the user. On the contrary, if the volume of transactions of the card user exceeds the credit limit or the user is an ill-credited man/woman, it transmits data for informing that the credit transactions are impossible to the terminal 11 (step S17).

Then, if the terminal 11 receives the transaction approval from the transaction approval determining unit 17, it performs the transactions (step S16), and issues a receipt. The receipt issued at this time does not require a signing procedure. This is because the authentication of the card user has been completed using the fingerprint of the card user.

Thereafter, if the transactions are completed, the card information and credit information of the user such as the credit limit and the reserved points of the card user should be changed. Accordingly, the user authentication unit 13 transmits the changed particulars of the card information and credit information according to the transactions of the card user to the management server 15. In order for the user authentication unit 13 to be logged in the management server 15, a proper number or an identification (ID) given to the user authentication unit 13 is required, and a password is also required to heighten the security. If the user authentication unit 13 transmits the ID and the password to the management server 15, the management server 15 confirms the ID and the password, and approves the connection.

After receiving the changed particulars of the card user, the management server 15 transfers the changed particulars to the user authentication units 13 of the respective member stores. The changed particulars received are stored in the database unit 24 of the respective user authentication unit 13.

As described above, the credit transaction system according to the first embodiment of the present invention can be implemented by installing the user authentication unit 13 in the respective member store without any change of the existing credit transaction system. Especially, since the authentication of the card user is performed in the member store, it is possible to authenticate the card user even when the network is disconnected, and the time required for the transactions is reduced. The above-described credit transactions are not limited to the settlement of the good purchase, but include diverse acts related to a card such as credit information of a card user, inquiry and change of the particulars of the card user.

### Second Embodiment

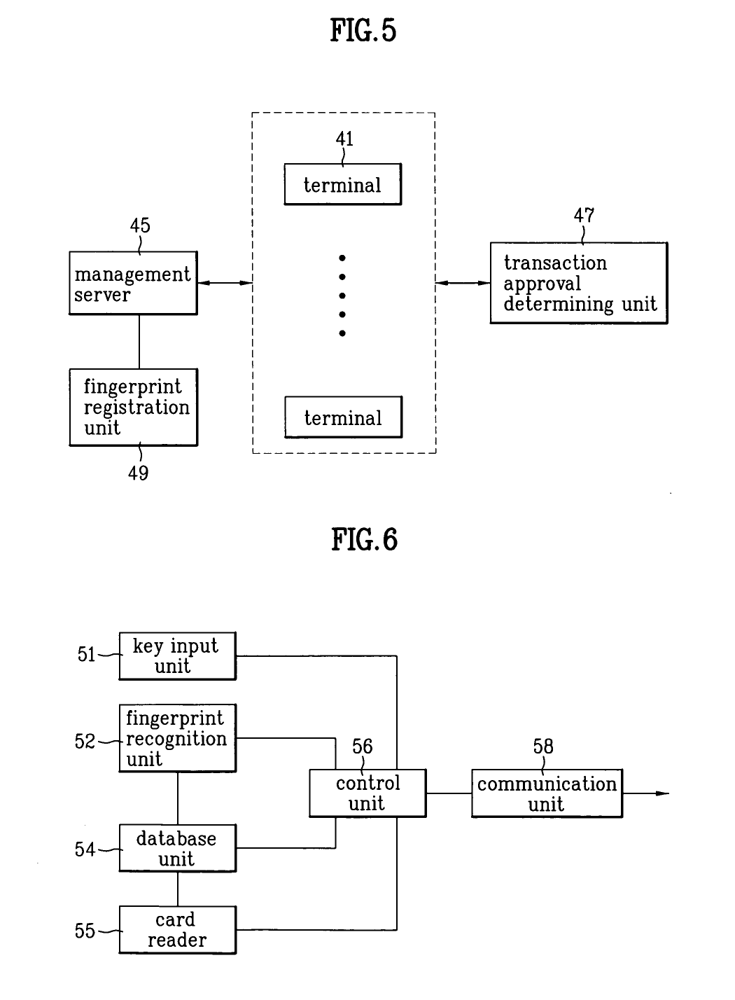

FIG. 5 illustrates a block diagram of a credit transaction system according to the second embodiment of the present invention. As shown in FIG. 5, the credit transaction system according to the second embodiment of the present invention includes a terminal 41 for credit transactions which recognizes the fingerprint of a card user and authenticates the card user. The terminal 41 recognizes the fingerprint of a card user, authenticates whether the card user is a customer registered in the corresponding credit card company by comparing the fingerprint of the card user with pre-registered fingerprint information, and then performs the transactions. The terminals 41 provided in the respective member stores or shops are connected to a server of the corresponding credit card company or banking company through the Internet.

The credit transaction system according to the second embodiment of the present invention further includes a management server 45, connected to the terminal 41 of the respective member store or shop, for correcting, deleting or updating information stored in the terminal 41, and a transaction approval determining unit 47 for receiving transaction particulars and card information of the card user from the terminal 41, confirming a credit status of the card user, and determining an approval/rejection of the transactions. Here, the management server 45 is connected to the terminals 41 in the respective member stores through the telephone networks, private lines or Internet. The transaction approval determining unit 47, which is the server of the credit card company, is also connected to the terminals 41 of the respective member stores through the telephone networks, private lines or Internet.

The credit transaction system according to the second embodiment of the present invention may further include a fingerprint registration unit 49 for registering the fingerprints of the card users. It is possible to register the fingerprints using the terminals of the respective member stores, but it is preferable to register the fingerprints through the fingerprint registration units 49 in specified places designated by the credit card company for a thorough identity confirming procedure. The fingerprint registration unit 49 includes a fingerprint recognition unit for scanning the fingerprint of the card user, and a database unit for storing the fingerprints of the registered card users in a fixed format.

As shown in FIG. 6, the terminal 41 includes a fingerprint recognition unit 52, a database unit 54, a control unit 56, a card reader 55, a key input unit 51, an LCD (not illustrated), a printer (not illustrated), and a communication unit 58.

The fingerprint recognition unit 52 scans the fingerprint of the card user, converts the scanned fingerprint into fingerprint data, and provides the fingerprint data to the control unit 56. The fingerprint recognition unit 52 may be replaced with a biomedical sensor for recognizing biomedical information of the card user as described above. Meanwhile, the database unit 54 can store the fingerprints of the users registered in the credit card company in a fixed format, and also store therein diverse information of the card users such as the card numbers of users, credit limits, commission rates, points reserved according to the use of the card, etc. The control unit 56 judges whether the card user is a customer registered in the credit card company by comparing the fingerprint of the card user recognized by the fingerprint recognition unit 52 with the fingerprint data stored in the database unit 54. The card reader 55 reads information recorded in the card held by the card user, and transfers the information to the control unit 56. The key input unit 51 is composed of various kinds of function keys and numeral keys for manipulating the terminal 41. The LCD displays thereon the operation state of the terminal 41 or the transaction particulars under the control of the control unit 56. The printer issues a receipt under the control of the control unit 56. The communication unit 58 modulates data to match the characteristic of the communication network connected between the management server 45 and the credit card company, and transmits the modulated data.

It will be apparent that the credit transaction system according to the present invention further includes constituent elements required for the existing credit transaction system.

Now, the credit transaction method performed in the credit transaction system according to the second embodiment of the present invention will be explained.

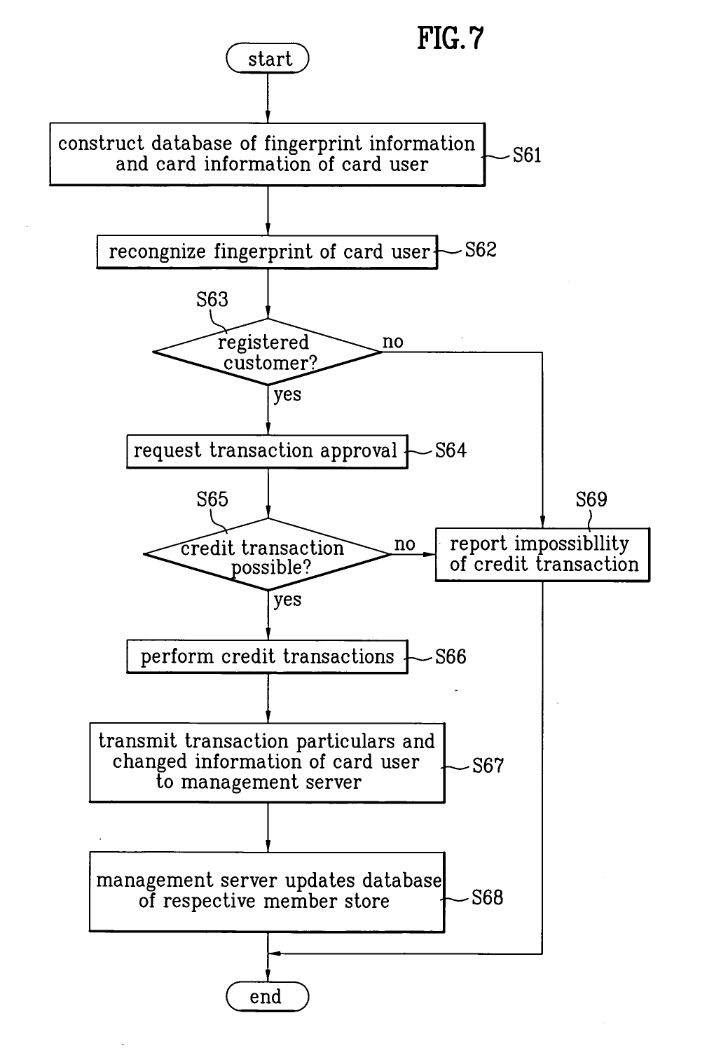

FIG. 7 illustrates a flowchart of a credit transaction process using the credit transaction system according to the second embodiment of the present invention. As shown in FIG. 7, the fingerprints of the card users should first be registered. The fingerprint registration process is the same as that of the first embodiment. In the same manner, a plurality of fingerprints can be registered with respect to one card number. The registered fingerprint data are stored in the database unit of the fingerprint registration unit 49.

The fingerprints as registered above are transmitted to and stored in the management server 45 in the form of data. The management server 45 transfers the registered fingerprints and the corresponding card information to the terminals 41 in the respective member stores through a communication network. The terminal 41, which received the fingerprints and the card information, stores them in the internal database unit 54 to construct a database (step S61).

The management server 45 transmits the fingerprints of the card users registered at any time and the corresponding card information to the terminal 41 to update the database unit 54 of the terminal 41. Here, the management server 45 and the database unit 54 of the terminal 41 can store therein diverse information of the card users such as the card numbers of users, credit limits, commission rates, points reserved according to the use of the card, etc., in addition to the fingerprints of the registered users. Accordingly, even if the terminal 41 is not connected to the management server 45 due to an obstacle of the management server 45 or network disconnection, the authentication of the card user can be performed using the data stored in the database unit 54.

Thereafter, if the card user presents the card in a member store to purchase goods or obtain services, the card of the user is read through the card reader 55 of the terminal 41, and the fingerprint of the card user is scanned through the fingerprint recognition unit 52 of the terminal 41 (step S62). At this time, the process of reading the card of the user through the terminal 41 may be omitted. For example, if the card user does not hold the card, only the fingerprint of the card user is scanned without reading the card.

Then, if the card is read through the card reader 55, the control unit 56 of the terminal 41 calls the fingerprint corresponding to the card number among the fingerprint data stored in the database unit 54, and judges whether the card user is a customer registered in the corresponding credit card company by comparing the fingerprint of the card user scanned by the fingerprint recognition unit 52 with the fingerprint stored in the database unit 54 (step S63).

Meanwhile, if the card is not read through the card reader 55, the control unit 56 confirms if there is a fingerprint that coincides with the fingerprint scanned by the fingerprint recognition unit 52 among the fingerprint data stored in the database unit 54. If the fingerprint that coincides with the scanned fingerprint is stored in the database unit 54, the card user is judged to be a registered customer, and if not, the card user is judged not to be a registered customer.

If the card user is authenticated through the above-described authentication procedure, the terminal 41 displays a message for requesting an input of the transaction particulars of the card user. Thereafter, the transaction particulars of the card user, i.e., the price of the good that the card user purchased, are inputted to the terminal 41 through the key input unit 51.

Then, the terminal 41 transfers the transaction particulars of the corresponding card user and the card information to the transaction approval determining unit 47 of the credit card company or banking company through the communication network to request the transaction approval (step S64). Here, the card information that the terminal 41 transfers to the transaction approval determining unit 47 may be read out from the database unit 54 or the management server 45. In other words, in order to transmit the latest updated card information to the transaction approval determining unit 47, it is preferable to read out the card information stored in the management server 45, but in the case that the network between the terminal 41 and the management server 45 is disconnected, the terminal 41 transmits the card information stored in the database unit 54.

The transaction approval determining unit 47 judges whether to approve the transaction by inquiring about the credit status of the card user (step S65). For example, if the volume of transactions of the card user is within the credit limit and the user is not an ill-credited man/woman, the transaction approval determining unit 47 approves the transactions of the user. On the contrary, if the volume of transactions of the card user exceeds the credit limit or the user is an ill-credited man/woman, it transmits data for informing that the credit transactions are impossible to the terminal 41 (step S69).

Thereafter, if the terminal 41 receives the transaction approval from the transaction approval determining unit 47, it performs the transactions (step S66), and issues a receipt. The receipt issued at this time does not require a signing procedure. This is because the authentication of the card user has been completed using the fingerprint of the card user.

Thereafter, if the transactions are completed, the card information and the credit information of the user such as the credit limit and the reserved points of the card user are changed. Accordingly, the terminal 41 should transmit the changed particulars of the card information and the credit information according to the transactions of the card user to the management server 45 (step S67). In order for the terminal 41 to be logged in the management server 45, a proper number or an identification (ID) given to the terminal 41 is required, and a password is also required to heighten the security. If the terminal 41 transmits the ID and the password to the management server 45, the management server 45 confirms the ID and the password, and approves the connection.

After receiving the changed particulars of the card user, the management server 45 transfers the changed particulars to the terminals 41 of the respective member stores. The changed particulars received are stored in the database unit 54 of the respective terminal 41 to update the database of the fingerprint information and the card information (step S68).

As described above, the credit transaction system according to the second embodiment of the present invention can be implemented by installing the terminal 41 for credit transactions which recognizes the fingerprint of the card user and authenticates the card user in the respective member store. In the same manner as the first embodiment, since the authentication of the card user is performed in the member store, it is possible to authenticate the card user even when the network is disconnected, and the time required for the transactions is reduced. The above-described credit transactions are not limited to the settlement of the good purchase, but include diverse acts related to a card such as credit information of a card user, inquiry and change of the particulars of the card user.

From the foregoing, it will be apparent that the credit transaction system according to the present invention provides the advantages that it can prevent the illegal use of a card by using a terminal for credit transactions which has functions of fingerprint recognition and authentication in a respective member store in order to confirm the identity of the card user. Also, since the authentication of the card user is performed in the member store, it is possible to authenticate the card user even when the network is disconnected, and the time required for the transactions is reduced.

It will be apparent to those skilled in the art than various modifications and variations can be made in the present invention. Thus, it is intended that the present invention covers the modifications and variations of this invention provided they come within the scope of the appended claims and their equivalents.

What is claimed is:

1. A credit transaction system using fingerprint information comprising:
a terminal for credit transactions which has a function of authenticating an identity of a card user using a fingerprint and transmits transaction particulars and card information of the card user;
a transaction approval determining unit for receiving the transaction particulars and the card information from the terminal, confirming a credit status of the card user, and informing an approval/rejection of the transactions to the terminal; and
a management server, connected to the terminal, for mutually communicating the fingerprint information and the card information with the terminal.

2. The credit transaction system of claim 1, wherein the terminal for the credit transactions comprises:
a fingerprint recognition unit for scanning the fingerprint of the card user;
a database unit for storing the fingerprint information and the card information of pre-registered card users; and
a control unit for confirming the identity of the card user by comparing the fingerprint of the card user scanned by the fingerprint recognition unit with the fingerprint information stored in the database unit.

3. The credit transaction system of claim 2, wherein the terminal for the credit transactions further comprises:
a card reader for reading information recorded in a card;
a key input unit for inputting the transaction particulars; and
a communication unit for transmitting/receiving data through a communication network.

4. The credit transaction system of claim 1, further comprising a fingerprint registration unit for scanning the fingerprint of the card user in order to register the fingerprint of the card user, and transmitting the fingerprint of the card user and the corresponding card information to the management server.

5. The credit transaction system of claim 1, wherein the management server transmits newly registered fingerprint information and changed card information to the terminal for the credit transactions.

6. A credit transaction method for a credit transaction system having a terminal for credit transactions, a transaction approval determining unit, and a management server, the method comprising:
(a) scanning a fingerprint of a card user using the terminal;
(b) confirming an identity of the card user by comparing the scanned fingerprint of the card user with fingerprint information stored in the terminal;
(c) requesting a transaction approval to the transaction approval determining unit; and
(d) the transaction approval determining unit determining an approval/rejection of the transactions after confirming a credit status of the card user.

7. The credit transaction method of claim 6, further comprising:
displaying a message for requesting an input of transaction particulars of the card user on the terminal after confirming the identity of the card user; and
inputting the transaction particulars of the card user through the terminal.

8. The credit transaction method of claim 6, wherein in order to request the transaction approval to the transaction approval determining unit, transaction particulars and card information of the card user are transmitted to the transaction approval determining unit.

9. The credit transaction method of claim 6, wherein at the step of confirming the identity of the card user, if the card of the card user is read out by the terminal, the terminal calls a fingerprint corresponding to the card number of the card user among fingerprint data stored therein and compares the fingerprint with the scanned fingerprint.

10. The credit transaction method of claim 6, wherein at the step of confirming the identity of the card user, if the card of the card user is not read out by the terminal, the terminal judges whether there is a fingerprint which coincides with the scanned fingerprint among fingerprint data stored therein.

11. The credit transaction method of claim 6, further comprising:
the terminal transmitting changed card information of the card user to the management server after the approval/rejection of the transactions is determined; and
updating respective terminals for the credit transactions using data of the management server.

12. A credit transaction system using fingerprint information comprising:
a user authentication unit for authenticating an identity of a card user by comparing a fingerprint of the card user with pre-stored fingerprint information;
a terminal for credit transactions for transmitting transaction particulars and card information of the card user in accordance with a result of the authentication performed by the user authentication unit;
a transaction approval determining unit for receiving the transaction particulars and the card information of the card user from the terminal, confirming a credit status of the card user, and informing an approval/rejection of the transactions to the terminal; and
a management server, connected to the user authentication unit, for mutually communicating the fingerprint information and the card information with the user authentication unit.

13. The credit transaction system of claim 12, wherein the user authentication unit comprises:
a fingerprint recognition unit for scanning the fingerprint of the card user;
a database unit for storing the fingerprint information and the card information of pre-registered card users; and
a control unit for authenticating the identity of the card user by comparing the fingerprint of the card user scanned by the fingerprint recognition unit with the fingerprint information stored in the database unit.

14. The credit transaction system of claim 12, further comprising:
a keyboard for inputting key values; and
a keyboard sharer for selectively transferring the key values of the keyboard to the terminal or the user authentication unit.

15. The credit transaction system of claim 14, wherein the keyboard sharer comprises:
a switch for switching connection of the keyboard to the terminal or the user authentication unit; and
a CPU for controlling the switch.

16. The credit transaction system of claim 14, further comprising a fingerprint registration unit for scanning the fingerprint of the card user in order to register the fingerprint of the card user, and transmitting the fingerprint of the card user and the corresponding card information to the management server.

17. A credit transaction method for a credit transaction system having a user authentication unit, a terminal for credit transactions, a transaction approval determining unit, and a management server, the method comprising:
(a) scanning a fingerprint of a card user using the user authentication unit;
(b) confirming an identity of the card user by comparing the scanned fingerprint of the card user with fingerprint information stored in the user authentication unit;
(c) transmitting card information and transaction particulars of the card user to the transaction approval determining unit;
(d) the transaction approval determining unit determining an approval/rejection of the transactions after confirming a credit status of the card user; and
(e) informing the approval/rejection of the transactions to the terminal.

18. The credit transaction method of claim 17, further comprising:
displaying a message for requesting an input of the transaction particulars of the card user on the terminal after authenticating the identity of the card user; and inputting the transaction particulars of the card user to the terminal.

19. The credit transaction method of claim 17, further comprising:
the user authentication unit transmitting changed card information of the card user to the management server after the approval/rejection of the transactions is reported to the terminal; and updating data stored in respective user authentication units using data of the management server.

20. The credit transaction method of claim 19, wherein the management server periodically transmits newly registered fingerprint information and changed card information to the user authentication unit.

21. The credit transaction method of claim 19, wherein the management server transmits newly registered fingerprint information and changed card information to the user authentication unit whenever the user authentication unit is logged in the management server.

22. The credit transaction method of claim 17, further comprising reading and providing the corresponding card information stored in the management server to the terminal after the identity of the card user is authenticated.
